(19) United States
(12) Patent Application Publication
(10) Pub. No.: US 2011/0222272 A1
(43) Pub. Date: Sep. 15, 2011

(54) Removable wirelessly-chargeable light-emitting device

(75) Inventor: Ming-Hsiang Yeh, Taipei City (TW)

(73) Assignee: Winharbor Technology Co., Ltd., New Taipei City (TW)

(21) Appl. No.: 12/929,951

(22) Filed: Feb. 28, 2011

(30) Foreign Application Priority Data
Mar. 9, 2010 (TW) 099204108

(51) Int. Cl. F21L 4/08

(52) U.S. Cl. 362/183

(57) ABSTRACT

The present invention provides a removable wirelessly-chargeable light-emitting device, which includes a body containing therein at least one light-emitting element and a receiver circuit. The body has a surface to which at least one fastening member is mounted, so that direct coupling with an article can be made through the fastening member and wireless charging can be made through the receiver circuit for energizing the light-emitting element to give off light.

### FIELD OF THE INVENTION

The present invention relates to a removable wirelessly-chargeable light-emitting device, and in particular to a removable wirelessly-chargeable light-emitting device that is wirelessly chargeable and is mountable to an article of fabric product or leather product to give off light.

### BACKGROUND OF THE INVENTION

Conventionally, to additionally mount a light-emitting element, such as a light-emitting diode (LED) to a personal item, such as garments, pants, shirts, underwear, leather belts (waist belts), raincoats, hats, or jackets, the only known practice is to mount a light-emitting element to a jacket or a hat to improve nighttime atmosphere, amusing, or aesthetics effect.

Further, these articles are made by applying proper jointing techniques, such as sewing and stitching, bonding (such as ultrasonic bonding), and/or thermal fusion, to joint multiple pieces of fabrics, which can be of different materials, different colors, and different shapes, to form a product. However, it has long been considered a difficult to mount a light-emitting element to these articles, thereby imposing undesired constraints to both the use and the configuration thereof.

Further, electrical power that is used to operate the light-emitting element is often supplied from a rechargeable battery, such as nickel-hydride battery and lithium battery. This rechargeable battery is re-chargeable by a charging device, which is electrically connected in a wired fashion to for example an electrical socket so that the electrical power for charging the battery is supplied through a cable or wire to the rechargeable battery. This limits the spatial range of usage and reduces the convenience of use.

Thus, it is desired to provide a light-emitting device that is wirelessly rechargeable and can be directly mounted to an article.

### SUMMARY OF THE INVENTION

An objective of the present invention is to provide a removable wirelessly-chargeable light-emitting device, and in particular a removable wirelessly-chargeable light-emitting device that is wirelessly rechargeable and can be directly mounted to an article.

To achieve the above objective, the present invention provides a removable wirelessly-chargeable light-emitting device, which is mountable to an article. The removable wirelessly-chargeable light-emitting device comprises a body; at least one light-emitting element, which is arranged in the body; a receiver circuit, which is housed in the body and is electrically connected to the light-emitting element, and comprises a rechargeable battery that stores electrical power; and at least one fastening member, which is mounted to a surface of the body and is positionable on the article to couple the body to the article. As such, the removable wirelessly-chargeable light-emitting device can be directly mounted to the article through the fastening member thereby completely overcoming the drawbacks of the existing device. Further, wireless charging can be realized through the receiver circuit and electrical power is stored in the rechargeable battery for subsequently supply to the light-emitting element for energization to give off light.

### BRIEF DESCRIPTION OF THE DRAWINGS

The present invention will be apparent to those skilled in the art by reading the following description of preferred embodiments thereof with reference to the drawings, in which:

FIG. 1 is a perspective view showing a removable wirelessly-chargeable light-emitting device according to a first embodiment of the present invention;

FIG. 2 is a side elevational view of FIG. 1;

FIG. 3 is a circuit diagram of the embodiment of FIG. 1;

FIG. 4 is a perspective view illustrating an application of the removable wirelessly-chargeable light-emitting device of FIG. 1;

FIG. 5 is a perspective view showing a removable wirelessly-chargeable light-emitting device according to a second embodiment of the present invention;

FIG. 6 is a side elevational view of FIG. 5;

FIG. 7 is a circuit diagram of the embodiment of FIG. 5;

FIG. 8 is a perspective view showing a removable wirelessly-chargeable light-emitting device according to a third embodiment of the present invention;

FIG. 9 is a side elevational view of FIG. 8;

FIG. 10 is a perspective view showing a removable wirelessly-chargeable light-emitting device according to a fourth embodiment of the present invention; and

FIG. 11 is a side elevational view of FIG. 10.

### DETAILED DESCRIPTION OF THE PREFERRED EMBODIMENTS

### First Embodiment

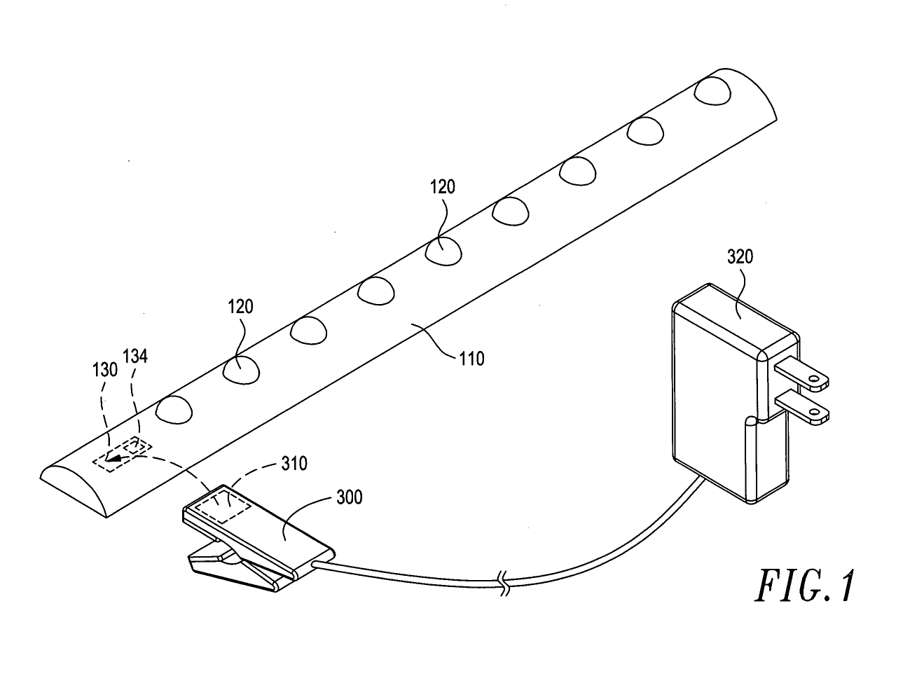

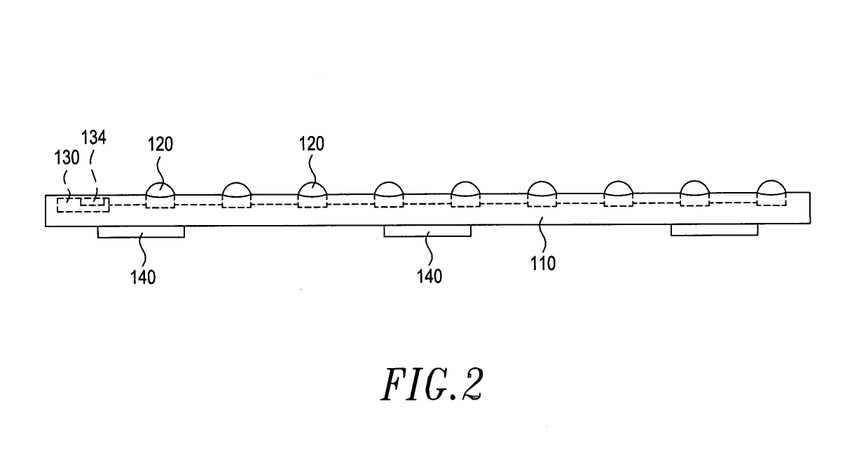

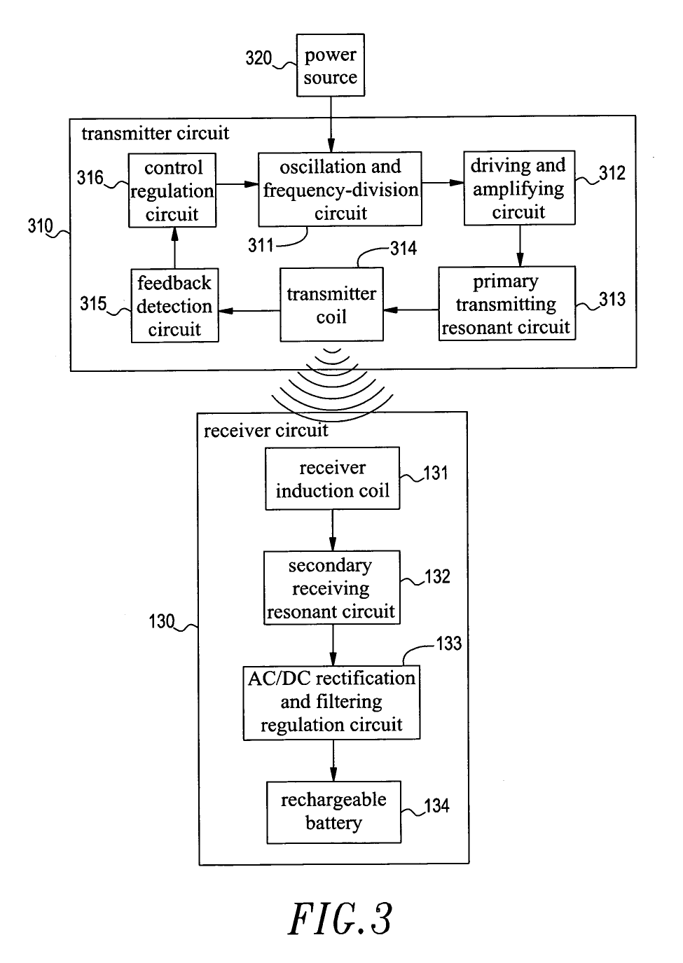

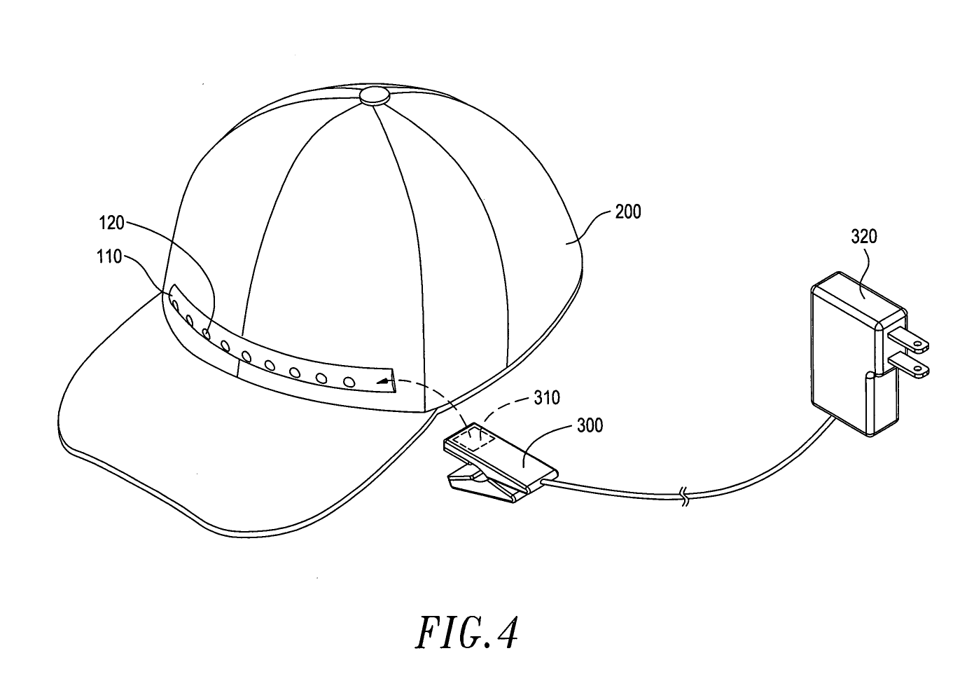

With reference to the drawings and in particular to FIGS. 1-4, which are respectively a perspective view, a side elevational view, a circuit block diagram of a removable wirelessly-chargeable light-emitting device according to a first embodiment of the present invention and a perspective view illustrating an application of the removable wirelessly-chargeable light-emitting device of the present invention, as shown in the drawings, the removable wirelessly-chargeable light-emitting device of the present invention comprises a body 110, at least one light-emitting element 120, a receiver circuit 130, and at least one fastening member 140 for being mountable to an article 200 and being wirelessly chargeable for energizing the light-emitting element 120 to give off light. The article can be for example garments, pants, shirts, underwear, leather bags, leather belts (waist belts), raincoats, hats, or jackets, but not limited thereto. A charging device 300 is coupled to the article 200 (by means of for example clamping, bonding, adhering, or mutual attraction). The charging device 300 comprises a transmitter circuit 310 and a power source 320 connected to the transmitter circuit 310. The power source 320 supplies electrical power to the transmitter circuit 310 and the electrical power is converted by the transmitter circuit 310 into an alternate-current (AC) signal.

The body 110 can be a woven member made of for example fabric, cotton, or a knitted material, or a flexible printed circuit board. In the embodiment shown in the drawings, the body 110 comprises a woven member. The light-emitting elements 120, which can be a light-emitting diode (LED) or an organic light-emitting diode (OLED), is arranged inside the body 110, or alternatively, the light-emitting element 120 can be woven within the body 110 in weaving the body 110, whereby a portion of the light-emitting element 120 is embedded in the body 110, while a remaining portion of the light-emitting element 120 is exposed outside the body 110. The portion of the light-emitting element 120 that is exposed outside the body 110 is covered by a waterproof layer (such as a waterproof polymerized material) (not shown) in order to improve water protection and sealing thereof.

The receiver circuit 130 is electrically connected to the light-emitting element 120 to allow the AC signal transmitted from the transmitter circuit 310 to be received by the receiver circuit 130. The receiver circuit 130 comprises a receiver induction coil 131, a secondary receiving resonant circuit 132 connected to the receiver induction coil 131, an AC/DC rectification and filtering regulation circuit 133 connected to the secondary receiving resonant circuit 132, and a rechargeable battery 134 connected to the AC/DC rectification and filtering regulation circuit 133. The rechargeable battery 134 can be a built-in rechargeable battery or an externally connected rechargeable battery for receiving an AC signal that is transmitted from the transmitter circuit 310 and received by the receiver induction coil 131. The AC signal is subjected to resonance by the secondary receiving resonant circuit 132 and is further subjected to rectification and regulation by the AC/DC rectification and filtering regulation circuit 133 so as to convert the AC signal into electrical power. The electrical power is then stored in the rechargeable battery 134 so that the rechargeable battery 134 may subsequently supply the electrical power to the light-emitting element 120.

The transmitter circuit 310 and the power source 320 can be connected in a wired fashion or a wireless fashion. The transmitter circuit 310 comprises an oscillation and frequency-division circuit 311 that is connected to the power source 320, a driving and amplifying circuit 312 connected to the oscillation and frequency-division circuit 311, a primary transmitting resonant circuit 313 connected to the driving and amplifying circuit 312, and a transmitter coil 314 connected to the primary transmitting resonant circuit 313, whereby the oscillation and frequency-division circuit 311 converts the electrical power supplied from the power source 320 into an AC signal, which is then amplified by the driving and amplifying circuit 312, and the amplified AC signal is subjected to resonance by the primary transmitting resonant circuit 313 to be transmitted by the transmitter coil 314 to the receiver circuit 130. Further, the transmitter circuit 310 may further comprise a feedback detection circuit 315 connected to the transmitter coil 314 and a control regulation circuit 316 connected to the feedback detection circuit 315 and the oscillation and frequency-division circuit 311, whereby the feedback detection circuit 315 feeds the AC signal transmitted by the transmitter coil 314 back to the control regulation circuit 316 to allow the control regulation circuit 316 to regulate the oscillation frequency of the oscillation and frequency-division circuit 311 in order to acquire the optimum result of resonance.

The fastening member 140 can be for example a button (such as snap button, snap fastener, Jeans button, long rivet, tubular rivet, rivet, rivet button, rivet fastener), a piece of double-sided adhesive tape, a hook-and-loop fastener, a length of rope, a hook, and magnets. The fastening member 140 is mounted to a surface of the body 110, whereby the body 110 can be coupled to the article 200 through for example fastening, bonding, adhering, hooking, or mutual attraction.

In the instant embodiment, the fastening member 140 comprises a hook-and-loop fastener, and the article is a hat. In other words, to mount the removable wirelessly-chargeable light-emitting device of the present invention to the article 200, the body 110 is directly attached to the article 200 through the fastening member 140.

Further, the receiver circuit 130 is mounted to the body 110, so that through proper coupling between the charging device 300 and the receiver circuit 130 (the charging device 300 and the receiver circuit 130 being coupled together through clamping in the drawings), the power source 320 is allowed to supply electrical power to the transmitter circuit 310, which converts the electrical power into an AC signal that is then transmitted by the transmitter coil 314 of the transmitter circuit 310 to the receiver circuit 130, so that the receiver circuit 130 can be charged to store the electrical power to the rechargeable battery 134 and to subsequently allow the rechargeable battery 134 to supply electrical power to the light-emitting element 120, thereby facilitating the convenience of use.

### Second Embodiment

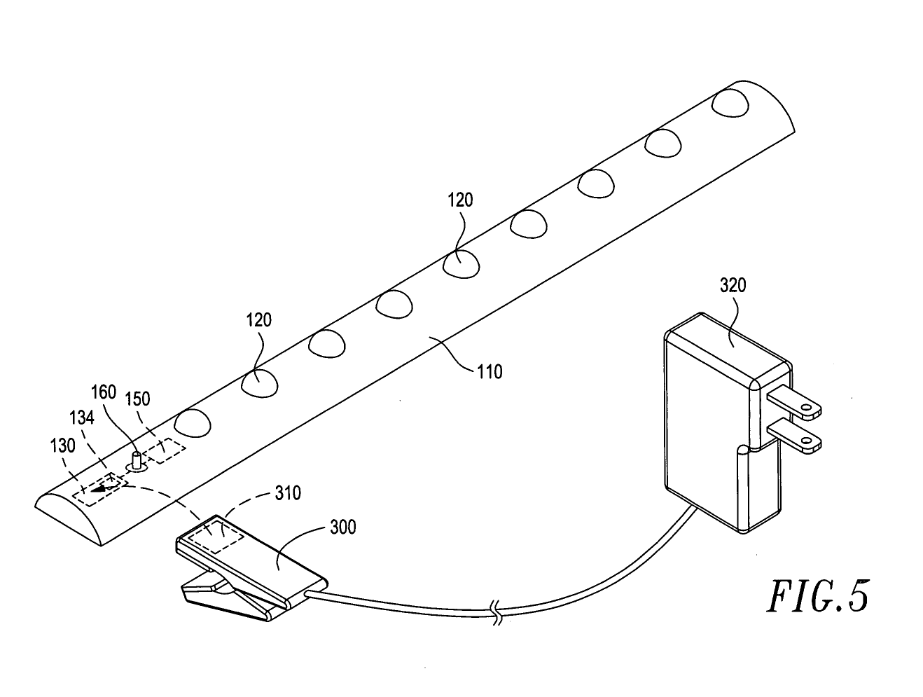

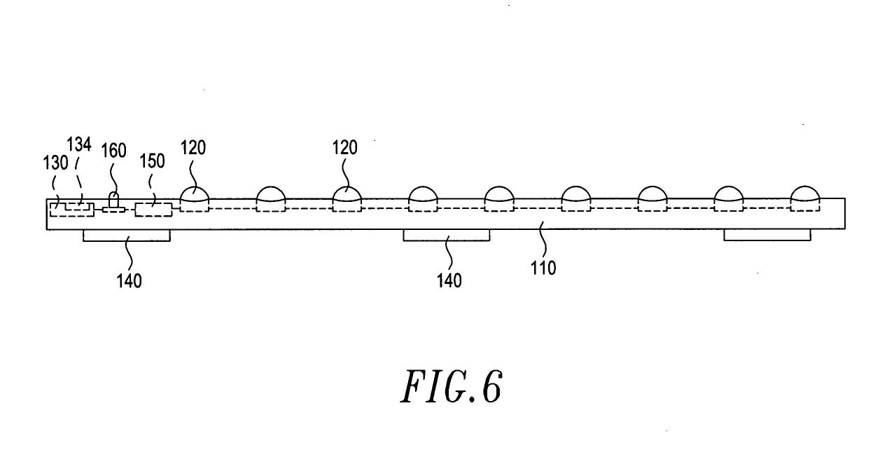

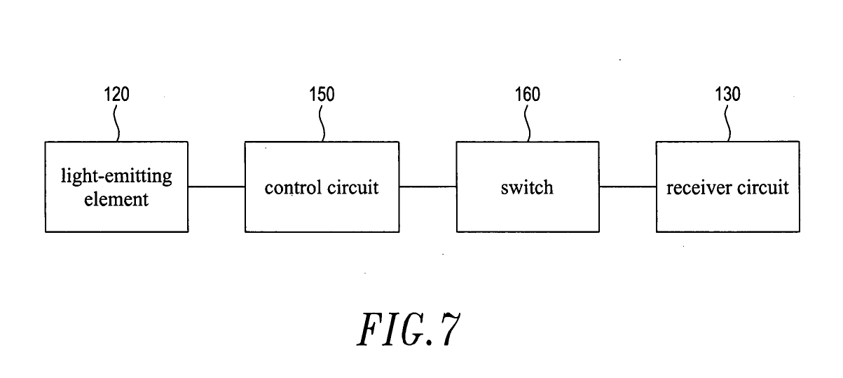

Referring to FIGS. 5-7, which are respectively a perspective view, a side elevational view, and a circuit block diagram of a removable wirelessly-chargeable light-emitting device according to a second embodiment of the present invention, the light-emitting device of this embodiment and the manufacturing method thereof are substantially identical to those of the previous embodiment in structure, except a control circuit 150 and a switch 160 are additionally provided. The control circuit 150 and the switch 160 are arranged inside the body 110. The control circuit 150, the switch 160, and the receiver circuit 130 are electrically connected to the light-emitting element 120 for supply of electrical power from the rechargeable battery 134 of the receiver circuit 130 to the light-emitting element 120. The switch 160 performs controls to selectively light on or off the light-emitting element 120 and the control circuit 6 controls the lighting fashion of the light-emitting elements 2 (such as regular light emission, flashing, or lighting with various brightness).

### Third Embodiment

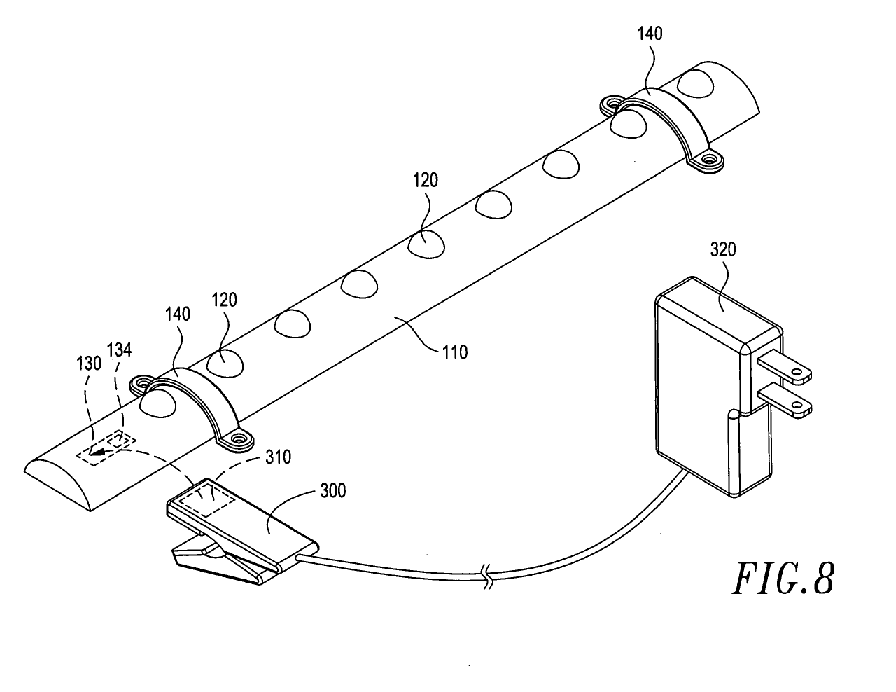

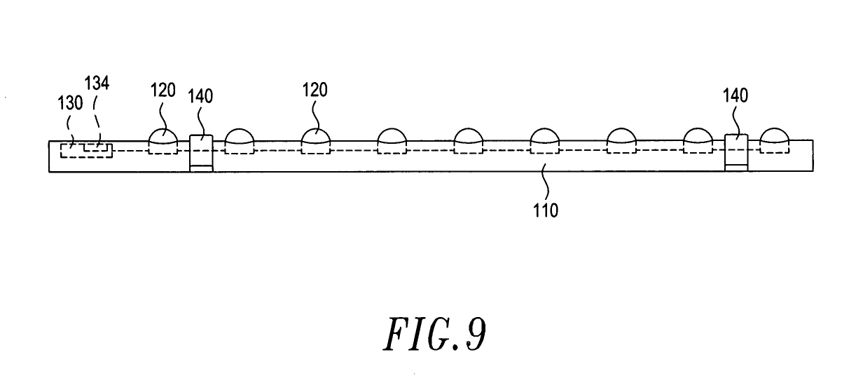

Referring to FIGS. 8 and 9, which are respectively a perspective view and a side elevational view of a removable wirelessly-chargeable light-emitting device according to a third embodiment of the present invention, the light-emitting device of this embodiment and the manufacturing method thereof are substantially identical to those of the previous embodiments, except a difference in that the fastening member 140 of this embodiment comprises a rivet button. The fastening member 140 is attached to a surface of the body 110 to allow the body 110 to be mounted to an article through the fastening member 140.

### Fourth Embodiment

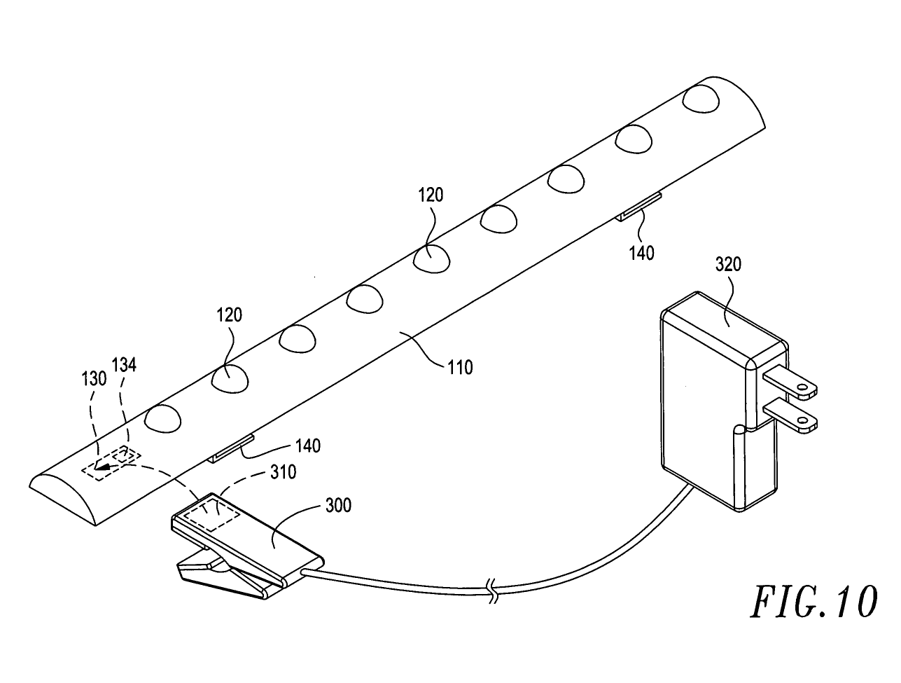

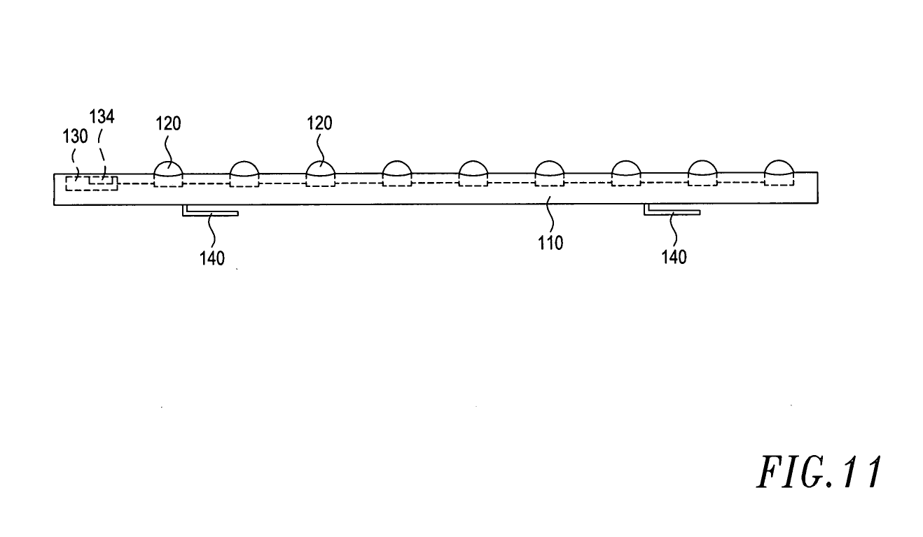

Referring to FIGS. 10 and 11, which are respectively a perspective view and a side elevational view of a removable wirelessly-chargeable light-emitting device according to a third embodiment of the present invention, the light-emitting device of this embodiment and the manufacturing method thereof are substantially identical to those of the previous embodiments, except a difference in that the fastening member 140 of this embodiment comprises a hook. The fastening member 140 is attached to a surface of the body 110 to allow the body 110 to be mounted to an article through the fastening member 140.

The feature of the removable wirelessly-chargeable light-emitting device according to the present invention is that at least one light-emitting element 120 and a receiver circuit 130 are arranged inside a body 110 and the receiver circuit 130 is in electrical connection with the light-emitting element 120. The receiver circuit 130 comprises a rechargeable battery 134. The body 110 has a surface to which at lest one fastening member 140 is mounted so that the removable wirelessly-chargeable light-emitting device of the present invention can be mounted to an article 200 through the fastening member 140.

Further, the body 110 is provided with a receiver circuit 130, which is provided for receiving an AC signal transmitted from a transmitter circuit 310 of a charging device 300 so that the receiver circuit 130 converts the received AC signal into electrical power to be stored in a rechargeable battery 134 of the receiver circuit 130. The receiver circuit 130 may then supply electrical power to the light-emitting element 120 for giving off light. Further, the light-emitting element 120 can be controlled by the switch 160 for lighting on or off and the control circuit 150 provides a control over the lighting fashion of the light-emitting element 120.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A removable wirelessly-chargeable light-emitting device, which is adapted to be coupled to an article, the removable wirelessly-chargeable light-emitting device comprising:
a body;
at least one light-emitting element, which is arranged in the body;
a receiver circuit, which is arranged in the body and is electrically connected to the light-emitting element, the receiver circuit comprising a rechargeable battery, which stores electrical power therein; and
at least one fastening member, which is mounted to a surface of the body, the fastening member being mountable to the article so as to couple the body to the article.

2. The removable wirelessly-chargeable light-emitting device as claimed in claim 1, wherein the body comprises one of a flexible printed circuit board and a woven member.

3. The removable wirelessly-chargeable light-emitting device as claimed in claim 1, wherein the light-emitting element comprises one of a light-emitting diode and an organic light-emitting diode.

4. The removable wirelessly-chargeable light-emitting device as claimed in claim 1, wherein the article is coupled to a charging device.

5. The removable wirelessly-chargeable light-emitting device as claimed in claim 4, wherein the charging device comprises a transmitter circuit and a power source connected to the transmitter circuit, the power source supplying electrical power to the transmitter circuit, the electrical power being converted by the transmitter circuit into an alternate-current signal.

6. The removable wirelessly-chargeable light-emitting device as claimed in claim 5, wherein the transmitter circuit comprises an oscillation and frequency-division circuit, a driving and amplifying circuit, a primary transmitting resonant circuit, and a transmitter coil, the oscillation and frequency-division circuit being connected to the power source, the oscillation and frequency-division circuit converting the electrical power supplied from the power source into an alternate-current signal, the driving and amplifying circuit being connected to the oscillation and frequency-division circuit, the driving and amplifying circuit amplifying the alternate-current signal that is formed by the oscillation and frequency-division circuit, the primary transmitting resonant circuit being connected to the driving and amplifying circuit, the primary transmitting resonant circuit providing resonance to the amplified alternate-current signal, the transmitter coil being connected to the primary transmitting resonant circuit and transmitting the alternate-current signal that is subjected to resonance by the primary transmitting resonant circuit to the receiver circuit.

7. The removable wirelessly-chargeable light-emitting device as claimed in claim 6, wherein the transmitter circuit further comprises a feedback detection circuit and a control regulation circuit, the feedback detection circuit being connected to the transmitter coil, the control regulation circuit being connected to the feedback detection circuit and the oscillation and frequency-division circuit, whereby the feedback detection circuit feeds the alternate-current signal transmitted by the transmitter coil back to the control regulation circuit to allow the control regulation circuit to regulate oscillation frequency of the oscillation and frequency-division circuit.

8. The removable wirelessly-chargeable light-emitting device as claimed in claim 1 further comprising a control circuit and a switch, wherein the control circuit and the switch are arranged in the body and the control circuit, the switch, and the receiver circuit are electrically connected to the light-emitting element.

9. The removable wirelessly-chargeable light-emitting device as claimed in claim 1, wherein the receiver circuit comprises a receiver induction coil, a secondary receiving resonant circuit, and an AC/DC rectification and filtering regulation circuit, the receiver induction coil receiving an alternate-current signal transmitted from the transmitter circuit, the secondary receiving resonant circuit being connected to the receiver induction coil, the secondary receiving resonant circuit providing resonance to the alternate-current signal received by the receiver induction coil, the AC/DC rectification and filtering regulation circuit being connected to the secondary receiving resonant circuit, the AC/DC rectification and filtering regulation circuit performing rectification and regulation of the alternate-current signal that is subjected to resonance by the secondary receiving resonant circuit so as to convert the alternate-current signal into electrical power, the rechargeable battery storing the electrical power obtained by the performance of the AC/DC rectification and filtering regulation circuit.

10. The removable wirelessly-chargeable light-emitting device as claimed in claim 1 further comprising a waterproof layer formed on the light-emitting element.

11. The removable wirelessly-chargeable light-emitting device as claimed in claim 1, wherein the mounting between the fastening member and the article is realized through one of fastening, bonding, adhering, hooking, or mutual attraction.
